(19) United States
(12) Patent Application Publication
(10) Pub. No.: US 2024/0421635 A1
(43) Pub. Date: Dec. 19, 2024

(54) LENGTH-ADJUSTABLE MASSAGER BASED ON WIRELESS INDUCTION POWER SUPPLY

(71) Applicant: Shenzhen Alltokee Technology Co., Ltd, Shenzhen (CN)

(72) Inventor: Minyi HUANG, Heyuan (CN)

(73) Assignee: Shenzhen Alltokee Technology Co., Ltd, Shenzhen (CN)

(21) Appl. No.: 18/353,929

(22) Filed: Jul. 18, 2023

(30) Foreign Application Priority Data
Jun. 15, 2023 (CN) 2023215222771

(51) Int. Cl. H02J 50/10; A61H 9/00; A61H 23/00; A61H 23/02; H02J 7/00

(52) U.S. Cl. CPC H02J 50/10; A61H 9/0057; A61H 23/006; A61H 23/0254; H02J 7/0042; A61H 2201/0192; A61H 2201/1685; A61H 2201/5005; A61H 2201/5097

(57) ABSTRACT

A length-adjustable massager based on wireless induction power supply, comprising a rod body and a massage component; The rod body is provided with a first PCB board, a first massage module, a power supply, and a wireless charging transmitter module; The first massage module, power supply, and wireless charging transmitter module are electrically connected to the first PCB board; The massage component is provided with a second PCB board, a second massage module, and a wireless charging receiver module, and the second massage module and the wireless charging receiver module are electrically connected to the second PCB board.

### CROSS-REFERENCE TO RELATED APPLICATIONS

The application claims priority to Chinese patent application No. 2023215222771, filed on Jun. 15, 2023, the entire contents of which are incorporated herein by reference.

### TECHNICAL FIELD

The present disclosure relates to a length-adjustable massager based on wireless induction power supply.

### BACKGROUND

The statement herein only provides background information related to the present invention and does not necessarily constitute prior art.

As the living standards rise, massage products are becoming more and more popular, and the types of massage products are increasing; In order to match different massage functions, there are also combination massage products on the market; As previously disclosed in Chinese Patent CN216598314U, a combination device allows consumers to combine different second components with the first component to achieve different functional combinations of the entire product.

However, there are also shortcomings in the existing combination device. Specifically, the combination device sets a first conductive member on the first component and a second conductive member on the second component. When the first conductive member contacts the second conductive member, the second component and the first component achieve conduction; Although this method achieves a conductive effect, its conductive members are exposed, and the conductive sheets are made of metal material, which are easy to oxidize and rust. Moreover, there is a current passing through the conductive sheets. Although the current is not high, it still brings discomfort and psychological barriers to consumers, making the market effect of the product not good enough.

For this reason, it is necessary to study a new technical solution to solve the above problems.

### SUMMARY

To address the shortcomings and deficiencies of the prior art mentioned above, the present invention provides a length-adjustable massager based on wireless induction power supply. By setting a wireless charging transmitter module on the rod body and a wireless charging receiver module adapted to it on the massage component, it enables the rod body to supply power for the massage component, solves the deficiency in the prior art of realizing the conductive connection between the massage component and the rod body through wires or conductive sheets, and therefore increases the safety factor and makes the product easier to be accepted by consumers.

To achieve the above objectives, the present invention adopts the following technical solution:
A length-adjustable massager based on wireless induction power supply, comprising a rod body and a massage component that can move back and forth along the lengthwise direction of the rod body; The rod body is provided with a first PCB board, a first massage module, a power supply, and a wireless charging transmitter module; The first massage module, power supply, and wireless charging transmitter module are electrically connected to the first PCB board;
The massage component is provided with a second PCB board, a second massage module, and a wireless charging receiver module, and the second massage module and the wireless charging receiver module are electrically connected to the second PCB board; Moreover, the wireless charging transmitter module is adapted to the wireless charging receiver module.

In some embodiments, the rod body has a first mounting chamber, the first massage module is installed in the first mounting chamber, and the first massage module corresponds to the front end of the rod body.

In some embodiments, the massage component has amounting ring, and the mounting ring is sleeved on the rod body and can slide back and forth on the rod body.

In some embodiments, the wireless charging receiver module is set in the mounting ring.

In some embodiments, the front section of the rod body is in a strip shape, and the mounting ring can slide out of the rod body from the front end of the rod body;

Alternatively, the rear section of the rod body is in a strip shape, and the mounting ring can slide out of the rod body from the rear end of the rod body;

Alternatively, the front and rear sections of the rod body are in a strip shape, and the mounting ring can slide out of the rod body from the front end and back end of the rod body.

In some embodiments, the rear section of the rod body is in a strip shape, and the front section of the rod body extends diagonally with a first massage end.

In some embodiments, the rod body comprises a first plastic inner shell and a first silicone jacket encased on the outside of the first plastic inner shell, and the first mounting chamber is formed inside the first plastic inner shell.

In some embodiments, a holding slot is provided between the first plastic inner shell and the first silicone jacket, and the wireless charging transmitter module is set in the holding slot.

In some embodiments, the first mounting chamber extends along the lengthwise direction of the first plastic inner shell, the power supply is a battery, and the first massage module, battery, and first PCB board are set in sequence from front to back in the first mounting chamber.

In some embodiments, the outer side of the first silicone jacket is provided with massage patterns.

The present invention has obvious advantages and beneficial effects over the prior art. Specifically, the above technical solution is mainly to set a wireless charging transmitter module on the rod body and a wireless charging receiver module adapted to it on the massage component, so that the rod body can supply power to the massage component, which solves the deficiency of the prior art that the massage component and the rod body need to be connected through wires or conductive sheets, making the product factor of safety higher and easier to be accepted by consumers; Furthermore, the massage component can move back and forth on the rod body, thereby adjusting the position of the massage component on the rod body to meet the needs of different consumers.

In order to more clearly illustrate the structural features and functions of the present invention, the following is a detailed description of the present invention in conjunction with the attached figures and specific embodiments.

### BRIEF DESCRIPTION OF DRAWINGS

FIG. 1 shows a three-dimensional schematic diagram of an embodiment of the present invention;

FIG. 2 shows a first exploded schematic diagram of an embodiment of the present invention;

FIG. 3 shows the cross-sectional schematic diagram of an embodiment of the present invention;

FIG. 4 shows a partially enlarged view of FIG. 3;

FIG. 5 shows a second exploded schematic diagram of an embodiment of the present invention.

Description of the key in the drawings:
10. Rod body; 101. First plastic inner shell; 102. First silicone jacket; 103. First massage end; 11. First PCB board; 12. First massage module; 13. Power supply; 14. Wireless charging transmitter module; 20. Massage component; 201. Mounting ring; 202. Second massage end; 203. Second plastic inner shell; 204. Second silicone jacket; 21. Second PCB board; 22. Second massage module; 23. Wireless charging receiver module.

### DETAILED DESCRIPTION OF THE EMBODIMENTS

The following will provide a clear and complete description of the technical solution in this embodiment of the present invention in conjunction with the attached figures, and it is clear that the described embodiment is only a preferred embodiment of the present invention.

It should be noted that when a component is referred to as “fixed to” another component, it may be directly attached to another component or there may be a centered component. When a component is considered to be “connected to” another component, it may be directly connected to another component or there may also be a centered component. The terms “vertical”, “horizontal”, “left”, “right”, and similar expressions used in this article are for illustrative purposes only and do not necessarily represent the exclusive implementation method.

Unless otherwise defined, all technical and scientific terms used in this article have the same meanings as those commonly understood by those skilled in the technical field of the present invention. The terms used in the specification of the present invention in this article are only for the purpose of describing specific embodiments and are not intended to limit the present invention. The term “and/or” used in this article includes any and all combinations of one or more related listed items.

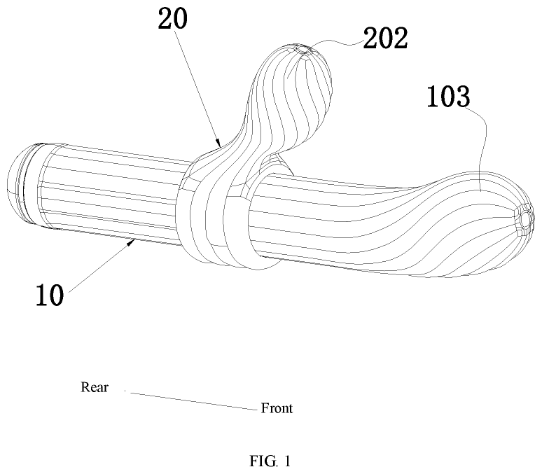

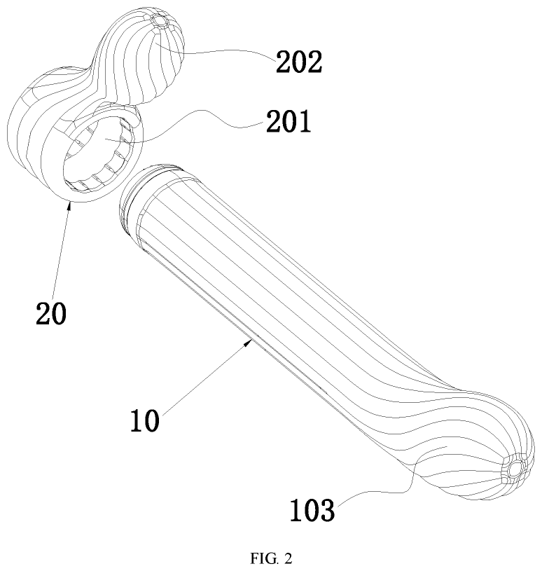

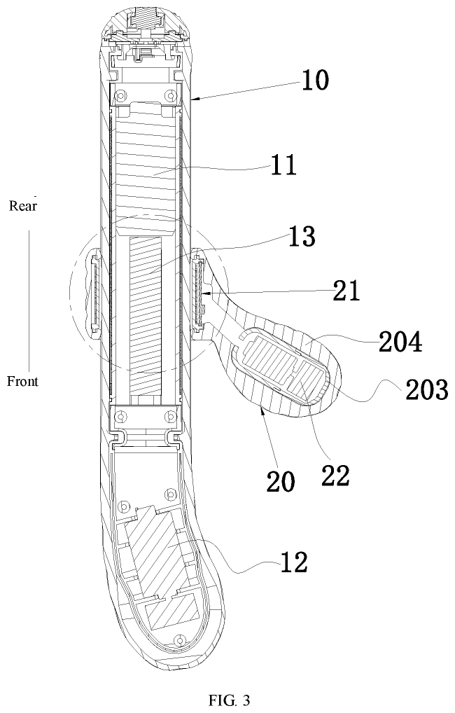

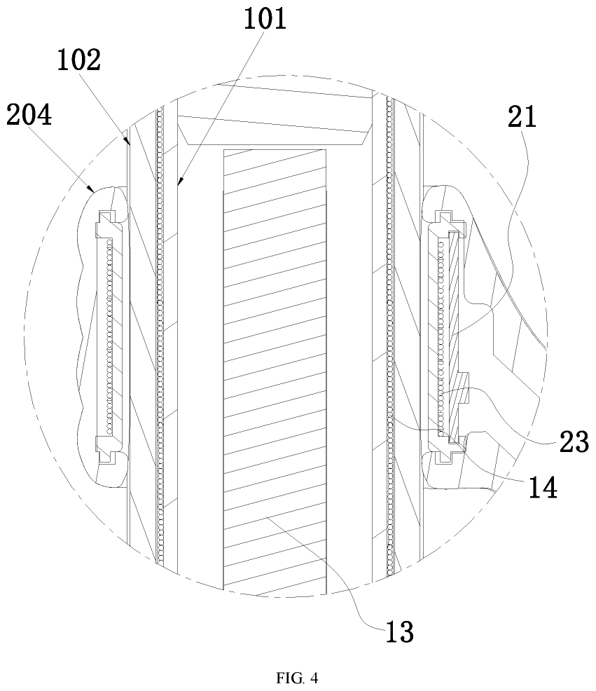

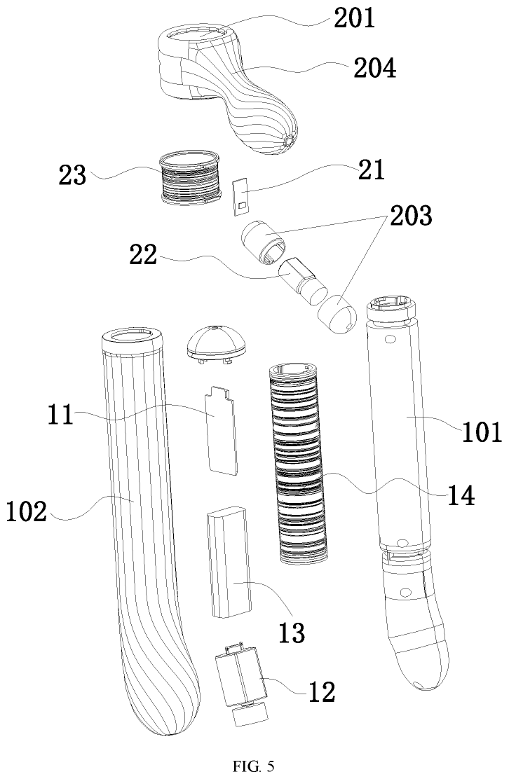

Referring to FIG. 1 to FIG. 5, in the embodiment of the present invention, a length-adjustable massager based on wireless induction power supply comprises a rod body 10 and a massage component 20 that can move back and forth along the lengthwise direction of the rod body 10; The rod body 10 is provided with a first PCB board 11, a first massage module 12, a power supply 13, and a wireless charging transmitter module 14; The first massage module 12, power supply 13, and wireless charging transmitter module 14 are electrically connected to the first PCB board 11;

The massage component 20 is provided with a second PCB board 21, a second massage module 22, and a wireless charging receiver module 23, and the second massage module 22 and the wireless charging receiver module 23 are electrically connected to the second PCB board 21; Moreover, the wireless charging transmitter module 14 is adapted to the wireless charging receiver module 23.

During operation, the wireless charging transmitter module 14 inside the rod body 10 transmits the electrical energy of the power supply 13 (usually a rechargeable battery) to the wireless charging receiver module 23 of the massage component 20 through wireless induction, and the wireless charging receiver module 23 supplies the electrical energy to the second PCB board 21 and the second massage module 22 after receiving the relevant electric energy, so that the second massage module 22 works; In this way, the setting of components such as wires or conductive sheets is omitted, and the problem of leakage caused by exposed wires or conductive sheets can also be avoided, giving a higher sense of safety; Furthermore, the massage component 20 can move back and forth on the rod body 10, thereby adjusting the distance from the front end of the rod body 10 to the massage component 20 to meet the massage needs of different users.

Specifically, the rod body 10 comprises a first plastic inner shell 101 and a first silicone jacket 102 encased on the outside of the first plastic inner shell 101, wherein the first plastic inner shell 101 has a first mounting chamber; Wherein,

The first mounting chamber extends along the lengthwise direction of the first plastic inner shell 101, and the first massage module 12 (provided with a first vibration motor), battery, and first PCB board 11 are set in sequence from front to back in the first mounting chamber; Moreover, the first massage module 12 (the first vibration motor) corresponds to the front end of the first mounting chamber (the rod body 10).

A holding slot is provided between the first plastic inner shell 101 and the first silicone jacket 102, and the wireless charging transmitter module 14 (usually a wireless charging transmission coil) is set in the holding slot, so as to ensure a better sealing and waterproofing of the wireless charging transmitter module 14 while also allowing the wireless charging transmitter module 14 to be closer to the outer surface of the bar body 10, making its connection with the wireless charging receiver module 23 more stable;

The first PCB board 11 is electrically connected with a charging port and an open/close button, and the charging port is preferably set at the rear end of the rod body 10.

Furthermore, the rod body 10 is in a strip shape, and the massage component 20 has a mounting ring 201. The mounting ring 201 is sleeved on the rod body 10, and the mounting ring 201 can slide back and forth on the rod body 10; The wireless charging receiver module 23 is preferably set on the mounting ring 201.

In practical application, a rod body 10 is provided with several massage components 20 with different functions (such as a suction massage component 20, a vibration massage component 20, a tapping massage component 20, etc.). In order to achieve interchangeability of massage components 20, the front section of the rod body 10 can be set in a strip shape, so that the mounting ring 201 can slide out of the rod body 10 from the front end of the rod body 10; Alternatively, the rear section of the rod body 10 is set in a strip shape, and the mounting ring 201 can slide out of the rod body 10 from the rear end of the rod body 10; Alternatively, the front and rear sections of the rod body 10 are both set in a strip shape, and the mounting ring 201 can slide out the rod body 10 from the front end and back end of the rod body 10;

As a preferred embodiment, the rear section of the rod body 10 in this embodiment is in a strip shape, and the front section of the rod body 10 extends diagonally with a first massage end 103.

Furthermore, in this embodiment, the massage component 20 extends diagonally forward on the mounting ring 201 with a second massage end 202, and the second massage module 22 corresponds to the second massage end 202 (the second massage module 22 has a second vibration motor, and the second vibration motor corresponds to the second massage end 202); Specifically, the second massage component 20 has a second plastic inner shell 203 and a second silicone jacket 204 set on the outer side of the second plastic inner shell 203, and the second massage module 22 is set inside the second plastic inner shell 204.

Preferably, the outer surfaces of the first silicone jacket 102 and the second silicone jacket 204 are both provided with massage patterns.

The design focus of the present invention is to set a wireless charging transmitter module on the rod body and a wireless charging receiver module adapted to it on the massage component, so that the rod body can supply power to the massage component, which solves the deficiency of the prior art that the massage component and the rod body need to be connected through wires or conductive sheets, making the product factor of safety higher and easier to be accepted by consumers; Furthermore, the massage component can move back and forth on the rod body, thereby adjusting the position of the massage component on the rod body to meet the needs of different consumers.

The above is only a preferred embodiment of the present invention and does not limit the technical scope of the present invention, so any minor modifications, equivalent changes, or modifications made to the above embodiments based on the technical essence of the present invention still fall within the scope of the technical solution of the present invention.

What is claimed is:

1. A length-adjustable massager based on wireless induction power supply, characterized in that, comprising a rod body and a massage component that can move back and forth along the lengthwise direction of the rod body; The rod body is provided with a first PCB board, a first massage module, a power supply, and a wireless charging transmitter module; The first massage module, power supply, and wireless charging transmitter module are electrically connected to the first PCB board;
The massage component is provided with a second PCB board, a second massage module, and a wireless charging receiver module, which are electrically connected to the second PCB board; Moreover, the wireless charging transmitter module is adapted to the wireless charging receiver module.

2. The length-adjustable massager based on wireless induction power supply of claim 1, characterized in that, the rod body has a first mounting chamber, the first massage module is installed in the first mounting chamber, and the first massage module corresponds to the front end of the rod body.

3. The length-adjustable massager based on wireless induction power supply of claim 1, characterized in that, the massage component has a mounting ring, and the mounting ring is sleeved on the rod body and can slide back and forth on the rod body.

4. The length-adjustable massager based on wireless induction power supply of claim 3, characterized in that, the wireless charging receiver module is set in the mounting ring.

5. The length-adjustable massager based on wireless induction power supply of claim 3, characterized in that, the front section of the rod body is in a strip shape, and the mounting ring can slide out of the rod body from the front end of the rod body;
Alternatively, the rear section of the rod body is in a strip shape, and the mounting ring can slide out of the rod body from the rear end of the rod body;
Alternatively, the front and rear sections of the rod body are in a strip shape, and the mounting ring can slide out of the rod body from the front end and back end of the rod body.

6. The length-adjustable massager based on wireless induction power supply of claim 5, characterized in that, the rear section of the rod body is in a strip shape, and the front section of the rod body extends diagonally with a first massage end.

7. The length-adjustable massager based on wireless induction power supply of claim 2, characterized in that, the rod body comprises a first plastic inner shell and a first silicone jacket encased on the outside of the first plastic inner shell, and the first mounting chamber is formed inside the first plastic inner shell.

8. The length-adjustable massager based on wireless induction power supply of claim 7, characterized in that, a holding slot is provided between the first plastic inner shell and the first silicone jacket, and the wireless charging transmitter module is set in the holding slot.

9. The length-adjustable massager based on wireless induction power supply of claim 6, characterized in that, the first mounting chamber extends along the lengthwise direction of the first plastic inner shell, the power supply is a battery, and the first massage module, battery, and first PCB board are set in sequence from front to back in the first mounting chamber.

10. The length-adjustable massager based on wireless induction power supply of claim 6, characterized in that, the outer side of the first silicone jacket is provided with massage patterns.
